(19) United States
(12) Patent Application Publication
(10) Pub. No.: US 2008/0255697 A1
(43) Pub. Date: Oct. 16, 2008

(54) VERTICAL FURNACE HAVING LOT-UNIT TRANSFER FUNCTION AND RELATED TRANSFER CONTROL METHOD

(75) Inventors: Jae-Woo CHUNG, Anyang-si (KR); Sang-Kook CHOI, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/053,741

(22) Filed: Mar. 24, 2008

(30) Foreign Application Priority Data
Apr. 16, 2007 (KR) 10-2007-0036817

(51) Int. Cl. G06F 17/00

(52) U.S. Cl. 700/112

(57) ABSTRACT

A system and method of transferring wafers by the lot to a vertical furnace are disclosed. The method includes receiving batch information related to a track-in operation and storing the batch information in a memory associated with the vertical furnace, wherein the batch information identifies a plurality of lots, sequentially transferring a plurality of carriers associated with the plurality of lots from an 1/0 port of the vertical furnace to a carrier stocker, transferring at least one of the plurality of carriers from the stock carrier to a wafer transfer stage before the carrier stocker receives all of the carriers in the plurality of carriers, and transferring wafers from at least one of the plurality of carriers from the wafer transfer stage to wafer boat.

### CROSS REFERENCE TO RELATED APPLICATIONS

This application claims priority under 35 U.S.C. §119 to Korean Patent Application 10-2007-0036817 filed on Apr. 16, 2007, the subject matter of which is hereby incorporated by reference.

### BACKGROUND OF THE INVENTION

The present invention relates to a vertical furnace—a commonly used type of semiconductor manufacturing equipment. More particularly, the present invention relates to a vertical furnace having a lot-unit transfer function, and a related wafer transfer control method.

In general, the fabrication of semiconductor devices on a substrate (or “wafer”) involves the repetitive application of various processes, such as a cleaning, diffusion, photoresist coating, exposure, developing, etching and ion injection etc. Thus, well designed semiconductor fabrication equipment facilitates the rapid performance of these processes.

Naturally, the customized nature of fabrication processes demands the use of highly specialized equipment. Yet, each individual piece of equipment should facilitate as much product throughput as possible. One approach to maximizing throughout allows multiple wafers grouped into identified “lots” to be simultaneously processed. Twenty to twenty-five wafers is a common lot size for many fabrication processes.

Each fabrication process is defined in its performance by a number of parameters (e.g., temperature, pressure, other environmental characteristics, etc.). The parameters associated with any given process may be provided to one or more equipment pieces via different communication channels (i.e., hardwired, wireless, RF, IR, etc.). Once received by the fabrication equipment, these parameters or a process recipe correlating the parameters may be stored in memory and used to control the fabrication equipment. Parameters and recipes may also be stored in a database associated with a host computer.

Once a process has been performed on a lot of wafers, the results are commonly checked using manual and/or automated test and measurement routines. While potential defects are being investigated by such routines, or once a process or outcome defect has been noted, the fabrication equipment may be placed in interlock state.

When an interlock operation occurs in a piece of fabrication equipment, an alarm signal may sound to force a technician to intervene. Following this manual intervention, the technician reports conditions related to the interlock to a process engineer. In turn, the process engineer may be required to calculate adjustments, check parameters or programming instructions for the relevant equipment. Once such verification calculations or examinations are complete, the engineer informs the technician and the technician may release the interlock, allowing the fabrication equipment to continue normal operation.

In “batch type” semiconductor fabrication equipment, multiple lots forming each batch and commonly arranged a relatively large wafer boat to undergo processing simultaneously or sequentially An identification table is used to track critical data associated with the batch type fabrication equipment. For example, the table or list may indicate the use of monitor wafers, the number of lots being run in a batch, the sequence of particular lots in the batch, the number of wafers in each lot, product run identification data, etc.

One batch type piece of fabrication equipment is disclosed, for example, in U.S. Pat. No. 5,942,012, the subject matter of which is hereby incorporated by reference. This equipment includes a heater within a vertical furnace. The heater surrounds a reaction tube inside the main body of the vertical furnace and is associated with a wafer boat. In the wafer boat, a plurality of wafers “W” are stacked vertically at intervals, and the wafer boat is used to load/unload the wafers in/from the vertical furnace. The heater is also associated with a wafer conveyor having a pincette including a movement member, lift member and rotary member, that facilitates the loading/unloading of wafers in/from the wafer boat.

Figure (FIG) 1 and FIG. 2. are schematic views of this conventional piece of fabrication equipment. As shown in FIG. 1, a wafer boat 23 is constructed of four support bars 23a formed from a material like quartz. Wafer boat 23 is fixed on a bottom plate 23b along the wafer contour. The position of each support bar 23a conforms to holding grooves on the edge of each wafer. Wafer conveyor 24 is provided with five pincettes 24a to carry multiple wafers at once. One of the pincettes is independently retractable from the remaining four pincettes to carry a wafer. In FIG. 1, a reference number 25 indicates a cover capable of closing, or rotating over a bottom opening of heating furnace 21 while the wafer is transferred between wafer boat 23 and an associated wafer carrier.

Wafer transfer stages 31 are arrayed opposed to a drop position for wafer boat 23 across wafer conveyor 24. Wafer transfer stage 31 is configured to place individual wafer carriers C containing a load of wafers into one of three stages arranged in a vertical direction.

In a region located above wafer transfer stage 31, a carrier stocker 32 is arranged to hold multiple carriers C ready to respectively accept various designated wafers, such as processed wafer, dummy wafers, reserve wafers, monitor wafers, etc.

A carrier conveyor 4 is disposed at a position opposed to wafer transfer stage 31, carrier stocker 32, and a carrier stage 33. Carrier stage 33 serves as an inlet/outlet(I/O) port through which the individual carriers C holding wafers are loaded/unloaded to/from the equipment. In the illustrated example, four carriers C are held in a horizontal row (in the X direction) with the wafer outlet ports facing upward.

In FIG. 1, carrier stage 33 is conceptually illustrated as a single element, but in actual implementation each carrier stage 33 is arranged with respect to a corresponding carrier C. Carrier stage 33 is provided with a member by which it may be turned inward on a horizontal pin 4a to rest on its side. In this position, each carrier C may be transferred by carrier conveyor 4. Carrier conveyor 4 is provided with an arm 43 that is rotatable in the Z direction to hold and transfer carriers C. Wafer carrier C is provided with a lift table 42 which is movable up and down along a support bar 41 in the X direction.

In FIG. 2, “F” indicates an air filter disposed to in a front panel of the main body of the equipment above an I/O port. A user touch panel 5 is associated with the equipment as shown in FIGS. 1 and 2. Touch panel 5 functions as a control mechanism and typically includes a display.

In many pieces of conventional batch-type fabrication equipment, such as the one illustrated in FIGS. 1 and 2, the constituent I/O port is configured to operate in relation to one or two wafer lots. Yet, the equipment may define a batch as between two and six lots. As a result, the software controlling the transfer of lots into, through, and from the equipment will often be limited to operation in relation to a defined batch size.

Thus, when two carriers are positioned at the I/O port, the wafer conveyor transfers the carriers to the carrier stocker. However, the fabrication equipment does not transfer the wafers received from the carriers to the wafer boat until the cassette stocker is fully stocked with an expected number of wafer lots. Thus, unnecessary process time may be consumed waiting for other sub-systems and components of the fabrication equipment to operate while waiting for the cassette stocker to fill. This delay decreases fabrication throughput and overall productivity. For example, where a batch is defined as six lots, the fabrication process is delayed until the carrier stocker is filled with six lots before transferring the wafers via the wafer transfer stage to the wafer boat. The commensurate time waiting for six lots to be collected decreases productivity

### SUMMARY OF THE INVENTION

In one embodiment, the invention provides a semiconductor fabrication system comprising; an operator interface server facilitating user designation of a batch comprising a plurality of lots, configuring related batch information, and generating control commands associated with the batch information, a host computer responsive to the control commands received from the operator interface, defining a recipe controlling a fabrication process, and generating commands controlling a track-in operation transferring wafers to/from a vertical furnace on a lot by lot basis, wherein the vertical furnace comprises, an I/O port receiving a plurality of carriers associated with the plurality of lots, a wafer carrier conveyor sequentially transferring the plurality of carriers from the I/O port to a stock carrier, a wafer transfer stage receiving the plurality of carriers from the stock carrier, and a wafer conveyor transferring wafers from the plurality of carriers positioned in the wafer transfer stage to a wafer boat, wherein transfer of the plurality of carriers from the stock carrier to the wafer transfer stage and transfer of the wafers from the carriers positioned in the wafer transfer stage to the wafer boat concurrently occur during transfer of the plurality of carriers from the I/O port to the stock carrier.

In another embodiment, the invention provides a method of transferring wafers by the lot to a vertical furnace, the method comprising; receiving batch information related to a track-in operation and storing the batch information in a memory associated with the vertical furnace, wherein the batch information identifies a plurality of lots, sequentially transferring a plurality of carriers associated with the plurality of lots from an I/O port of the vertical furnace to a carrier stocker, transferring at least one of the plurality of carriers from the stock carrier to a wafer transfer stage before the carrier stocker receives all of the carriers in the plurality of carriers, and transferring wafers from at least one of the plurality of carriers from the wafer transfer stage to wafer boat.

### BRIEF DESCRIPTION OF THE DRAWINGS

FIG. 1 is a perspective view illustrating an entire structure of heating device according to a conventional art;

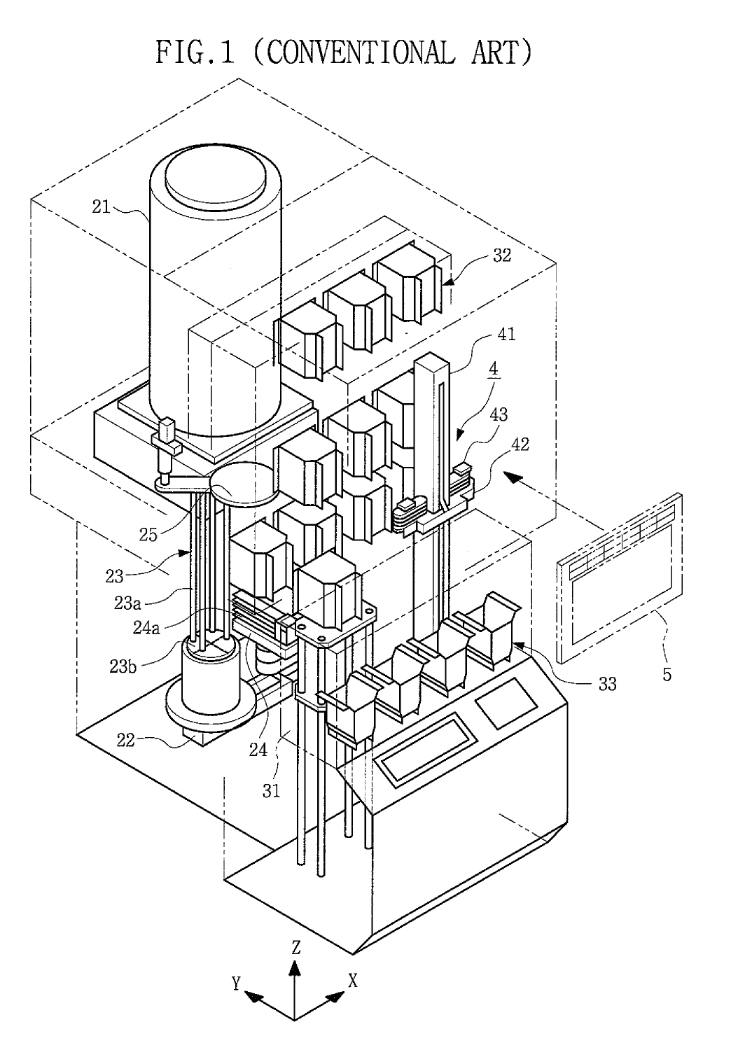

FIG. 2 is a longitudinal section illustrating an entire structure of heating device shown in FIG. 1;

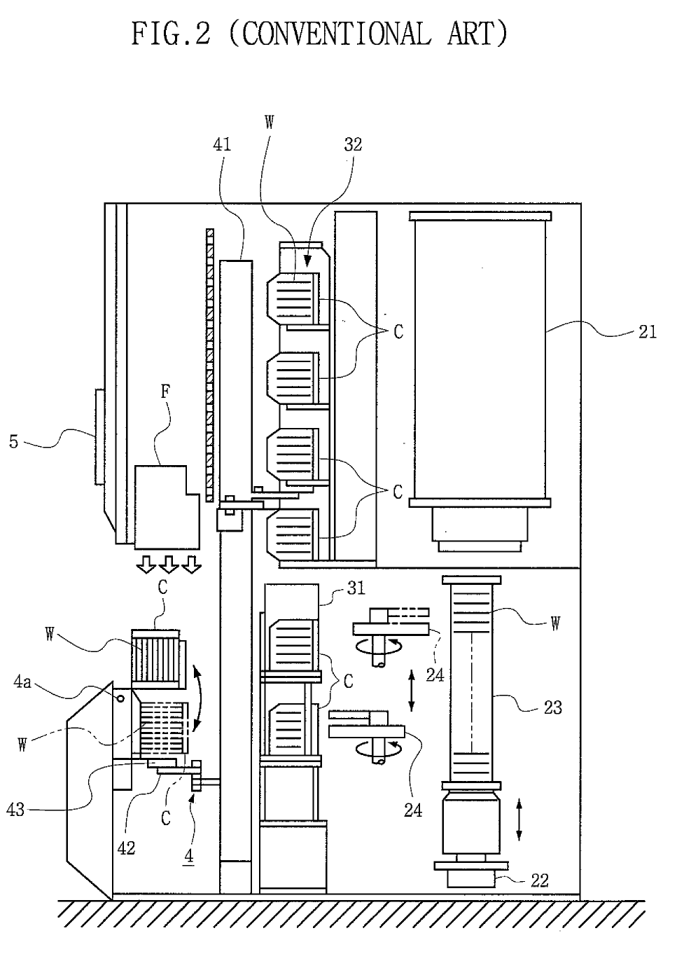

FIG. 3 is a block diagram of a system managing a semiconductor manufacturing apparatus according to an embodiment of the invention;

FIG. 4 illustrates a configuration of process equipment for carrying wafer carriers by the lot;

FIG. 5 illustrates an example of screen display to input batch information for a track-in and lot addition batch information according to an embodiment of the invention; and

FIG. 6 is a flowchart in transferring wafers by the lot according to an embodiment of the invention.

### DESCRIPTION OF EMBODIMENTS

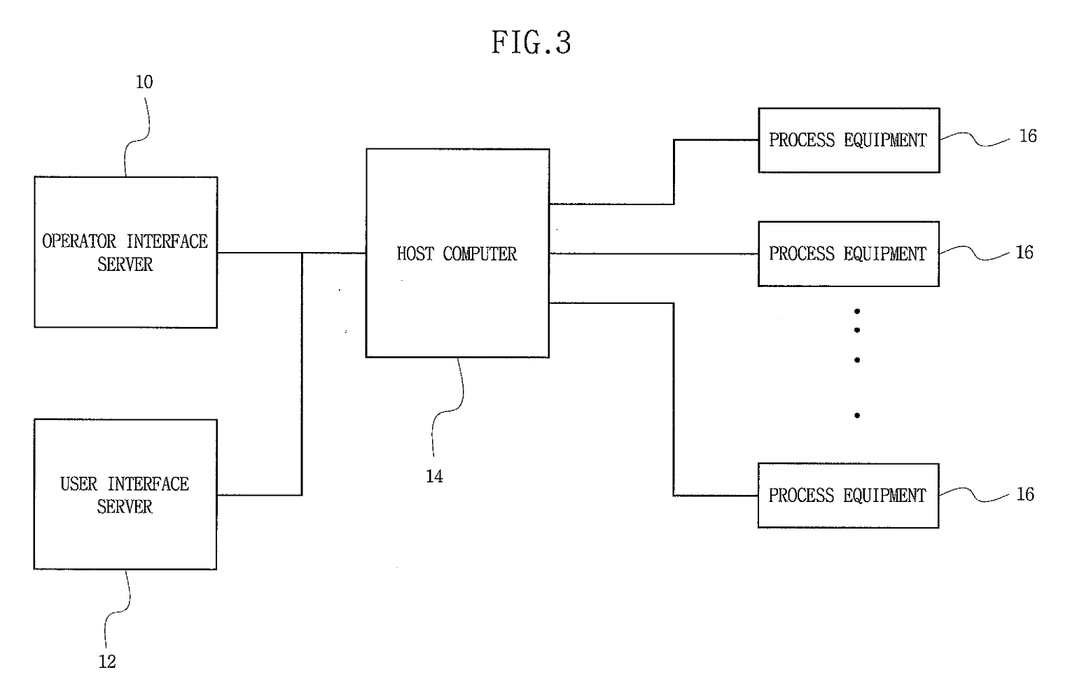

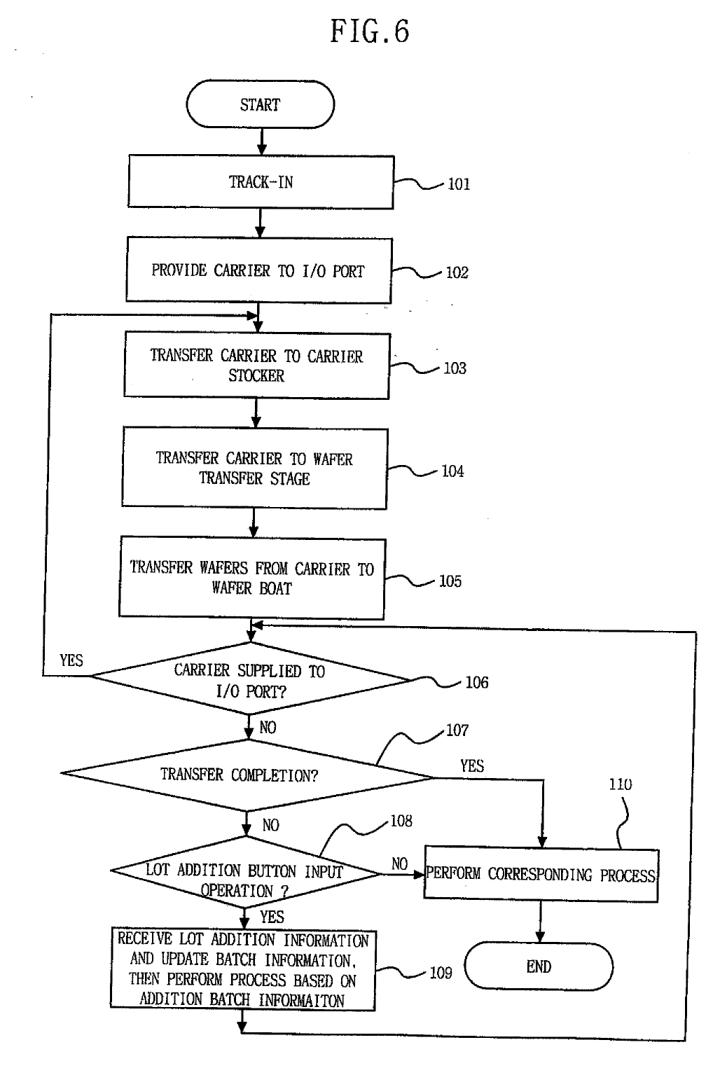

Embodiments of the present invention now will be described more fully hereinafter with reference to FIGS. 3 and 6. The invention may, however, be embodied in many different forms and should not be construed as being limited to only the embodiments set forth herein. Rather the illustrated embodiments are provided as teaching example of the making and use of the broader invention.

FIG. 3 is a general block diagram of a system adapted for use in the control and management of semiconductor fabrication equipment and may find application in the context of embodiments of the invention.

As shown in FIG. 3, an operator interface server 10 stores one or more software routines and related parameters defining a fabrication process in relation to one or more pieces of fabrication equipment. Operator interface server 10 may be flexibly used in this context to control process conditions by referencing data associated with monitor wafer(s), generating commands designating a particular number of loaded wafer lots, designating the respective position of a wafer lot, etc. Conventional coding techniques and commercially available programs may be used to program operator interface server 10.

A user interface server 12 may be variously implemented using conventional hardware platforms, communication links and related software to form a user interface for the system. User interface server 12 may be adapted to allow a user (e.g., a process engineer or technician) to inquire into the operating state of various pieces of fabrication equipment 16. Such inquiry may be made remotely.

A host computer 14 may be implemented using a general purpose computer such as a laptop or personal computer (PC). Host computer 14 is adapted to receive command(s) and associated data from operator interface server 10 and user input from user interface server 12 in order to control the operation of fabrication equipment 16. Host computer 14 may also be used to receive and store real time data generated by fabrication equipment 16. Such data, or graphical representations thereof, may be returned to a database associated with operator interface server 10, and/or provided to user interface server 12. Host computer 14 may also control the transfer of wafer carriers by lot when a “track-in” command is communicated by operator interface server 10. Wafers are loaded to one or more of the fabrication equipment pieces 16 where various fabrication processes are performed. For example, operation of the various components and sub-systems described hereafter may be controlled and coordinated by software routines running on host computer 14 in order to facilitate the transfer of wafers to a wafer boat in anticipation of a fabrication process.

In certain embodiments, host computer 14 may be associated with its own database used to store various statistical process control (SPC) information. This information may be subsequently used to analyze and/or define process conditions and parameters related to respective processes.

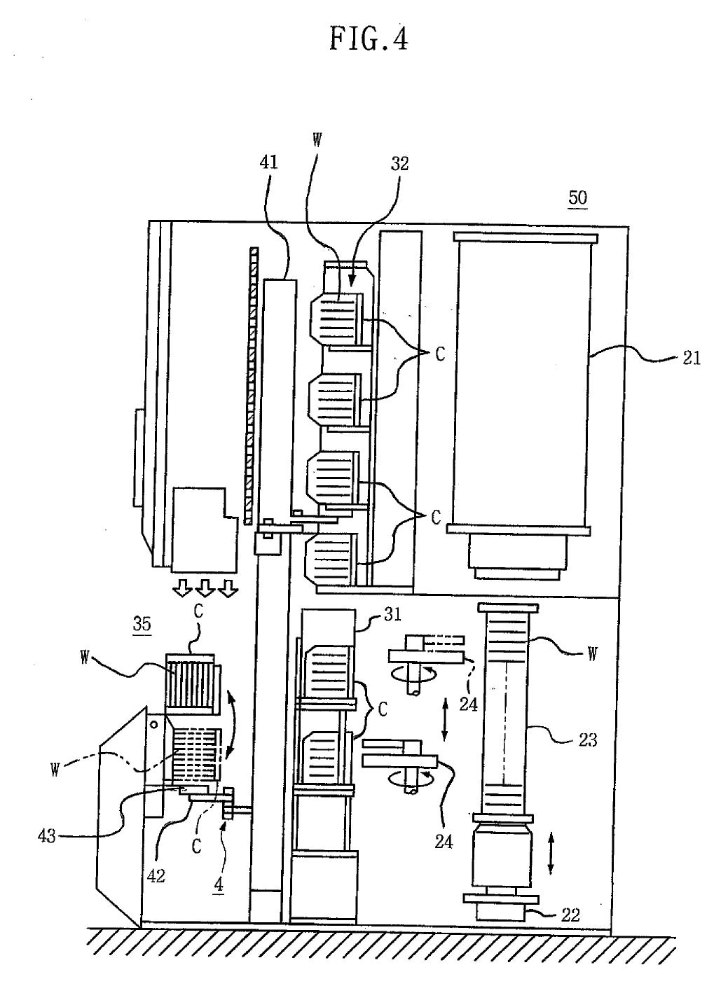

FIG. 4 is a partial schematic illustration of a vertical furnace 50 susceptible to the benefits of the present invention. Vertical furnace 50 is one example of fabrication equipment 16 requiring intelligent transfer of wafers by lot under the control of a system such as the one illustrated in FIG. 3. However, the invention is not strictly limited to only vertical furnaces.

Similar to the conventional vertical furnace described previously, vertical furnace 50 comprises a vertical heating furnace 21, a wafer boat 23, and a wafer conveyor 24.

Vertical heating furnace 21 may be formed in one embodiment by a heater surrounding a reaction tube disposed within the main body of vertical furnace 50. However, the particular implementation of the vertical heating furnace is not limiting to the disclosed invention.

Wafer boat 23 collects and vertically stacks a plurality of wafers (W) to be processed in vertical heating furnace 21. Wafers are stacked at defined intervals within wafer boat 23 to facilitate efficient processing. In this manner, wafer boat 23 and a wafer boat elevator 22 are primarily adapted to load/unload wafers in/from vertical heating furnace 21. In one embodiment, wafer boat 23 is implemented with four vertical support bars fabricated from a material such as quartz and positioned to engage respective holding grooves formed in the wafers.

In one embodiment, wafer conveyor 24 comprises at least one pincette comprising a moving member, a lift member and a rotary member. However, implemented wafer conveyor 24 loads/unload wafers in/from wafer boat 23. In one more specific embodiment, wafer conveyor 24 comprises five (5) pincettes designed to transfer five wafers at once. However, one of the five pincettes may be independently retractable from the remaining four pincettes in order to carry a single designated wafer.

One or more wafer transfer stages 31 are arrayed oppose to wafer boat 23 across wafer conveyor 24. Wafer transfer stage 31 is adapted to accommodate a plurality of wafer carriers C, each holding a number of wafers. In the illustrated embodiment, wafer transfer stage 31 is implemented in vertical stages.

In the illustrated embodiment, a carrier stocker 32 is disposed above wafer transfer stage 31. Multiple wafer carriers C may be loaded into carrier stocker 32. The wafer carriers loaded into carrier stocker 32 may be variously used to hold wafers awaiting processing, dummy wafers, supplemental wafers, monitor wafers, etc.

A carrier conveyor 4 is disposed along a support bar 41 proximate wafer transfer stage 31 and carrier stocker 32 in order to facilitate the transfer of wafer carriers. Carrier conveyor 4 includes a lift table 42 provided with an arm 43 as a rotary member capable of vertically lifting and swing transferring a wafer carrier C. Lift table 42 may appropriately position a wafer carrier C using an associated movement member.

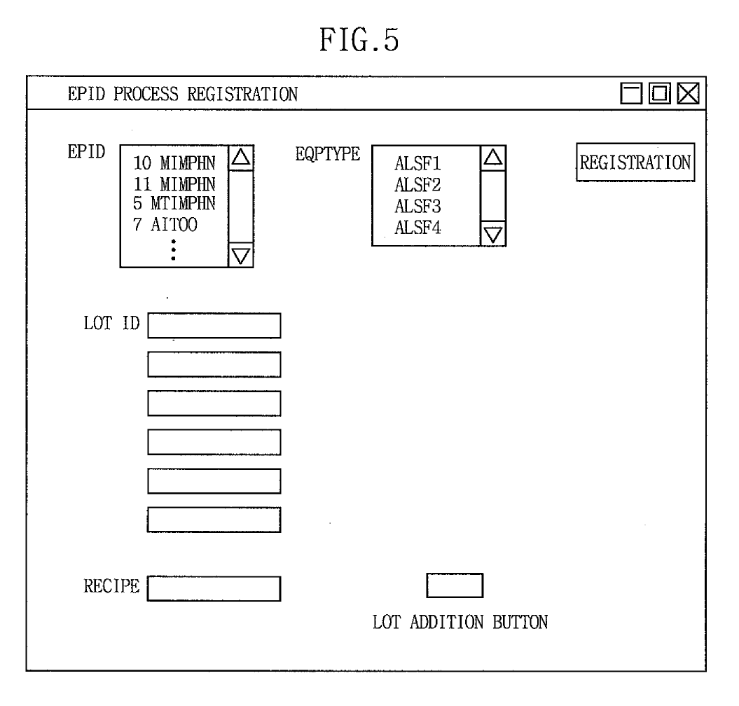

FIG. 5 illustrates one example of a user control screen (hereafter a “track-in screen”) communicating input batch information for a track-in operation and associated lot addition batch information according to an embodiment of the invention. FIG. 6 is a flowchart summarizing a transfer method for wafers by lot according to an embodiment of the invention.

Operation of one exemplary embodiment of the invention will be described with reference to FIGS. 3 to 6.

According to defined software routines, operator interface server 10 automatically determines the number of wafer lots designated for supply to a particular piece of fabrication equipment in relation to a designated batch. The track-in screen of FIG. 5 may accordingly indicate this information. Operator interface server 10 then sends batch information, including in one embodiment the appropriate use of one or more monitor wafer(s), to host computer 14.

Host computer 14 produces a process recipe appropriately indicating the use or nonuse of monitor wafer(s) once a number (e.g., one through six) of wafer lots has been designated. In one embodiment, the use of monitor wafers may be made on a per lot basis.

In the working example, fabrication equipment 16 and host computer 14 are assumed to be connected via a LAN cable. Using this communication link, host computer 14 transfers the process recipe to fabrication equipment 16. The recipe will usually include a specific name (or other designation information) appropriately indicating the batch information received from operator interface server 10.

Transfer of the recipe to fabrication equipment 16 causes the fabrication equipment to load the recipe data and transition from an idle state to a stand-by state. Once fabrication equipment indicates full receipt of the recipe, the designated process is now read to run on fabrication equipment 16. However, so long as fabrication equipment 16 remains in the idle state, it indicates to host computer 14 that additional recipe data is required or that a recipe load error has occurred. Sometimes a recipe load error will occur when batch information communicated to fabrication equipment 16 is damaged. This may be remedied by resetting the batch information, following which the recipe will load and fabrication equipment 16 may enter the standby state.

An exemplary operation for transferring wafer carriers by lot in the context of the working example will now be described.

Operator interface server 10 applies batch information associated with a track-in operation for a particular fabrication process to host computer 14 via a competent communication channel. For example, when selecting a process registration by equipment identification (EPID) using a track-in screen associated with operator interface server 10, an EPID process registration menu screen such as the one shown in FIG. 5 may be used. EPID and equipment type (EQPTYPE) may be selected using the menu screen, and a wafer lot identification (LOT ID) input. Then a process recipe version or condition (RECIPE) may be input and a registration button actuated.

These actions transfer input batch information to host computer 14. Once host computer 14 receives the batch information batch information update is performed—, as necessary. Typical batch information for the track-in operation includes data indicating the number and identity of lots associated with batch, use of a monitor wafer(s), etc.

At this point, host computer 14 is ready to start operation of fabrication equipment 16 in relation to the designated batch, and initiate control over an associated transfer of wafer carriers on a lot by lot basis In the working example, it is assumed that vertical furnace 50 may process from between two and six wafer lots. It is further assumed for purposes of illustration that a designated batch includes only four wafer lots.

This being the case, the user may make use of the lot addition button provided on the EPID process registration menu screen shown in FIG. 5 during identification of the track-in operation. When so used, lot additional batch information is provided from operator interface server 10 to host computer 14. The lot additional batch information may be used to supplement the recipe data, or more typically add additional non-batch related wafer lots to the current fabrication process. With this information, host computer 14 may control operation of fabrication equipment 16 to add two additional lots into the four lot batch being run in the working example. Thus, a full load of six wafer lots may be processed without disrupting the wafer lot designations for the batch of interest.

Referring now to the flowchart of FIG. 6, operator interface server 10 sends batch information to host computer 14 and a track-in operation is started (101). Then, host computer 14 based on received batch information related to the track-in operation a wafer carrier C is provided to I/O port 35 of the vertical furnace 50 (102). The wafer carrier may be manually or automatically loaded.

Once the wafer carrier is provided to the I/O port, carrier conveyor 4 is operated to position the wafer carrier in carrier stocker 32 (103). The wafer carrier is then transferred from carrier stocker 32 to wafer transfer stage 31 (104). Using wafer conveyor 4, wafers from the wafer carrier loaded in wafer transfer stage 31 are sequentially transferred by lot to wafer boat 23 (105). The software routines controlling the transfer operation then determine whether another wafer carrier is being provided to the I/O port (106). If another wafer carrier is being provided to the I/O port, the transfer method returns to step 103 and repeats until no additional wafer carriers are being presented to the I/O port (106=no).

Next, another determination is made as to whether the number of lots transferred to the fabrication equipment correctly corresponds to the designated batch size and whether the fabrication equipment is at maximum lot capacity or a recipe indicated maximum lot capacity (107). If yes, the fabrication process is performed (110).

However, if the current batch does not fully consume the fabrication equipment's full capacity, the provision of lot additional information is possible (108). If no lot additional information is apparent, the fabrication process is performed (110). However, where lot additional information is provided (109), this information is used to supplement the current batch information. As the lot additional information may require the provision of additional wafer lots to the fabrication equipment, the control method returns to step 106.

The foregoing control method, unlike conventional approaches, allows the continuous and ongoing transfer of wafers from stock carrier 32 to wafer stage 31 and from wafer stage 31 to wafer boat 23 without waiting for stock carrier 32 to be fully loaded with carriers associated with lots in a designated batch. This approach saves considerable time in the transfer of wafers to wafer boat 23. Additionally, the full capacity of vertical furnace 50 may be utilized when a designated batch contains fewer then the maximum number of wafer lots allowed by the constituent fabrication equipment and recipe.

Although the continuous transfer of carriers from stock carrier 32 to wafer transfer stage 31 has been illustrated as an example, the reverse is also true. That is, a transfer of wafer carriers from stock carrier 32 to I/O port 35 need not wait until all batch related wafer lots are positioned in stock carrier 32.

In this manner, one or more wafer carriers may be simultaneously (i.e., in parallel) transferred within vertical furnace 50 while another wafer carrier is being transferred from I/O port 35 to stock carrier 32.

Therefore, assuming that the time required to charge/discharge wafers per lot is about 2 minutes 30 seconds, and that a designated batch includes six lots, 12 minutes 30 seconds are required for each charge and discharge operation, and about 7 minutes 30 seconds is taken in the delivery of a discharged wafer carrier through the I/0 port. A great deal of this 32 minutes 30 seconds transfer time may be reduced by used of the control method described above.

As described above, in a batch type vertical furnace according to an embodiment of the invention, wafer carriers may be transferred by lot and the wafers charged/discharged before the carrier stocker is completely filled with wafer carrier lots corresponding to a designated batch, thereby reducing process wait time increasing productivity.

In addition, when capacity of the vertical furnace allows more lots than included in a designated batch, additional lots may be added to the track-in operation further enhancing productivity.

It will be apparent to those skilled in the art that modifications and variations can be made in the present invention without deviating from the scope of the invention. Thus, it is intended that the present invention cover any such modifications and variations of this invention provided they come within the scope of the appended claims and their equivalents.

What is claimed is:

1. A semiconductor fabrication system comprising:
an operator interface server facilitating user designation of a batch comprising a plurality of lots, configuring related batch information, and generating control commands associated with the batch information;
a host computer responsive to the control commands received from the operator interface, defining a recipe controlling a fabrication process, and generating commands controlling a track-in operation transferring wafers to/from a vertical furnace on a lot by lot basis;
wherein the vertical furnace comprises:
an I/O port receiving a plurality of carriers associated with the plurality of lots;
a wafer carrier conveyor sequentially transferring the plurality of carriers from the I/O port to a stock carrier;
a wafer transfer stage receiving the plurality of carriers from the stock carrier; and
a wafer conveyor transferring wafers from the plurality of carriers positioned in the wafer transfer stage to a wafer boat,
wherein transfer of the plurality of carriers from the stock carrier to the wafer transfer stage and transfer of the wafers from the carriers positioned in the wafer transfer stage to the wafer boat concurrently occur during transfer of the plurality of carriers from the I/O port to the stock carrier.

2. The system of claim 1, wherein the batch information comprises at least one of; a number of the plurality of lots, identity information for the plurality of lots, information regarding the use of one or more monitor wafers.

3. The system of claim 1, wherein the operator interface server receives and stores in a real time process data generated in relation to operation of the vertical furnace and wafers processed in the vertical furnace.

4. The system of claim 3, wherein the operator interface server is functionally associated with software generating a user track-in screen facilitating user definition of the batch.

5. The system of claim 4, wherein the user track-in screen comprises a mechanism for supplementing batch information with lot additional information associated with one or more additional lots to the plurality of lots in the batch.

6. A method of transferring wafers by the lot to a vertical furnace, the method comprising:
receiving batch information related to a track-in operation and storing the batch information in a memory associated with the vertical furnace, wherein the batch information identifies a plurality of lots;
sequentially transferring a plurality of carriers associated with the plurality of lots from an I/O port of the vertical furnace to a carrier stocker;
transferring at least one of the plurality of carriers from the stock carrier to a wafer transfer stage before the carrier stocker receives all of the carriers in the plurality of carriers; and
transferring wafers from at least one of the plurality of carriers from the wafer transfer stage to wafer boat.

7. The method of claim 6, wherein transferring wafers from at least one of the plurality of carriers from the wafer transfer stage occurs while the carrier stocker is receiving other ones of the plurality of carriers.

8. The method of claim 6, further comprising:
determining whether the transfer of the plurality of lots is completed and thereafter determining whether lot additional information is provided with the batch information.

9. The method of claim 8, wherein upon determining that lot additional information is provided with the batch information, sequentially transferring at least one additional carrier from the I/O port to the carrier stocker.

10. The method of claim 6, wherein the received batch information is configured at least in part by user inputs to a user track-in screen.

11. The method of claim 9, wherein the lot additional information is configured at least in part by user inputs to a user track-in screen.
